(19) United States
(12) Patent Application Publication
(10) Pub. No.: US 2010/0192787 A1
(43) Pub. Date: Aug. 5, 2010

(54) PRESS ANGLE CONTROL DEVICE, PRESS MACHINE FACILITY, AND PRESS ANGLE CONTROL METHOD

(75) Inventors: Dai Onishi, Tokyo (JP); Takeshi Takahashi, Tokyo (JP)

Correspondence Address: GRIFFIN & SZIPL, PC, SUITE PH-1, 2300 NINTH STREET, SOUTH, ARLINGTON, VA, 22204, US

(73) Assignee: IHI CORPORATION, Tokyo (JP)

(21) Appl. No.: 12/680,169

(22) PCT Filed: Aug. 25, 2008
(86) PCT No.: PCT/JP2008/065086

§ 371 Date: Mar. 25, 2010

(30) Foreign Application Priority Data
Sep. 27, 2007 (JP) 2007-251297

(51) Int. Cl. B30B 15/24

(52) U.S. Cl. 100/46

(57) ABSTRACT

There are provided a device and a method capable of reducing a press angle control error caused by a press load variation and of preventing a press load variation of one press machine from acting on the other press machine.

The device includes: a reference value output unit 25 which outputs a press angle reference value; and a press angle detection unit 27, a speed command unit 29, and a driving unit 31 which are provided for each press machine. The press angle detection unit 27 detects a press angle of the corresponding press machine and outputs a press angle detection value. The speed command unit 39 outputs a command speed value of a motor of the corresponding press machine on the basis of the press angle reference value and the press angle detection value. The driving unit 31 controls a speed of the motor of the corresponding press machine on the basis of the command speed value. The device further includes a correction unit 33 which corrects the press angle reference value or the command speed value so that a difference between the press angle reference value and the press angle is within a predetermined range.

### BACKGROUND OF THE INVENTION

1. Field of the Invention

The present invention relates to a press angle control device for a press machine facility provided with a plurality of press machines constituting a press line. Also, the present invention relates to a press machine facility provided with the press angle control device. Also, the present invention relates to a press angle control method for the press machine facility.

2. Description of the Related Art

In the past, a plurality of press machines constitutes a press line in which a plurality of pressing processes is carried out. At this time, a press angle control is carried out so that a press angle difference between the press machines is uniformly maintained or press angles of the press machines are synchronized with each other. A method and a device for performing the press angle control are disclosed in, for example, Japanese Patent No. 3682373 ‘SYNCHRONOUS CONTROL METHOD OF A PLURALITY OF PRESS MACHINES’ and Japanese Laid-open Patent Publication No. 2005-52855 ‘CONTROLLER FOR CONTINUOUS RUNNING OF MECHANICAL DRIVE TYPE TANDEM PRESS LINE’.

In the press angle control disclosed in Japanese Patent No. 3682373, on the basis of a difference between a press angle of a master press machine as a synchronization reference and a press angle of a slave press machine as a synchronization object, a correction amount of a command speed value input to a motor of the slave press machine is obtained, and the correction amount is added to the command speed value input to the motor, thereby synchronizing the press angles with each other.

In the press angle control disclosed in Japanese Laid-open Patent Publication No. 2005-52855, on the basis of a press angle of an upstream press machine, an angle command signal input to a downstream press machine is corrected, thereby performing a phase difference control in which a phase difference between the upstream press machine and the downstream press machine is uniformly maintained.

However, in the press angle control disclosed in Japanese Patent No. 3682373, since the press angle synchronization control is carried out on the basis of the press angle of the master press machine as a synchronization reference in order to synchronize the press angles with each other, when an actual motor speed of the master press machine varies due to a press load increasing during a pressing process, the variation acts on the slave press machine. As a result, a press angle difference occurs between the press machines, and thus a problem arises in that a large error may occur during the press angle control.

Also, in the press angle control disclosed in Japanese Laid-open Patent Publication No. 2005-52855, since the phase difference control is carried out on the basis of the upstream press machine as a reference in order to uniformly maintain the press angle difference between the plurality of press machines, when an actual motor speed of the upstream press machine varies due to a press load increasing during the pressing process, the variation acts on the downstream press machine. As a result, although it is necessary to uniformly maintain the press angle difference, the press angle difference largely varies, and thus a problem arises in that a large error may occur during the press angle control.

Therefore, an object of the invention is to provide a press angle control device, a press machine facility, and a press angle control method capable of reducing a press angle control error caused by a press load variation and of preventing a press load variation of one press machine from acting on the other press machine.

### SUMMARY OF THE INVENTION

In order to achieve the above-described object, according to the invention, there is provided a press angle control device for a press machine facility provided with a plurality of press machines constituting a press line, the press angle control device including: a reference value output unit which outputs a press angle reference value; and a press angle detection unit, a speed command unit, and a driving unit which are provided for each of the press machines, wherein the press angle detection unit detects a press angle of the corresponding press machine and outputs a press angle detection value, wherein the speed command unit outputs a command speed value to a motor of the corresponding press machine on the basis of the press angle reference value and the press angle detection value, wherein the driving unit controls a speed of the motor of the corresponding press machine on the basis of the command speed value, and wherein the press angle control device further comprises a correction unit which corrects the command speed value or the press angle reference value so that a difference between the press angle reference value and the press angle for each of the press machines is within a predetermined range.

According to the press angle control device for the press machine facility, the reference value output unit outputs the press angle reference value, the press angle detection unit detects the press angle of the corresponding press machine and outputs the press angle detection value, the speed command unit outputs the command speed value to the motor of the corresponding press machine on the basis of the press angle reference value and the press angle detection value, the driving unit controls a speed of the motor of the corresponding press machine on the basis of the command speed value, and the correction unit corrects the command speed value or the press angle reference value so that a difference between the press angle reference value and the actual press angle for each of the press machines is within a predetermined range, thereby reducing a difference (i.e., a press angle control error) caused by a press load variation.

Additionally, since the press angle reference value is independent from the press angle detection value of each press machine, the press angle reference value does not vary due to the press load variation. Also, since the press angle control is carried out on the basis of the press angle reference value, the press load variation of one press machine does not act on the other press machine.

According to the preferred embodiments of the invention, the correction unit corrects the command speed value or the press angle reference value so that a press angle difference between the adjacent press machines is within a predetermined range.

As described above, since the correction unit corrects the command speed value or the press angle reference value so that the press angle difference between the adjacent press machines is within a predetermined range, it is possible to reduce the press angle difference between the adjacent press machines and to perform a synchronization control or a phase difference control of the adjacent press machines.

According to the preferred embodiments of the invention, the correction unit corrects the command speed value or the press angle reference value so that the command speed value increases until a time point when a pressing process starts.

With such an operation of the correction unit, it is possible to efficiently reduce a difference between the press angle reference value and the press angle of the press machine. In general, since a press speed decreases due to the press load during a pressing process to thereby delay an advance of the press angle, a difference between the press angle reference value and the actual press angle tends to be maximum during the pressing process. According to the operation of the correction unit, since the command speed value or the press angle reference value is corrected so that the command speed value increases before the advance of the press angle is delayed due to the decrease of the press speed in accordance with the press load, it is possible to efficiently reduce a difference between the press angle reference value and the press angle during the pressing process, thereby reducing the maximum difference value.

According to the preferred embodiments of the invention, the correction unit corrects the command speed value or the press angle reference value so that the command speed value decreases after the pressing process starts.

With such a configuration, since the correction unit corrects the command speed value or the press angle reference value so that the command speed value decreases after the pressing process starts, it is possible to correct an excessive advance of the press angle due to the increase of the command speed value.

In order to achieve the above-described object, according to the invention, there is provided a press machine facility including: a plurality of press machines which constitutes a press line; and a press angle control device which controls press angles of the plurality of press machines, wherein the press angle control device includes: a reference value output unit which outputs a press angle reference value; and a press angle detection unit, a speed command unit, and a driving unit which are provided for each of the press machines, wherein the press angle detection unit detects a press angle of the corresponding press machine and outputs a press angle detection value, wherein the speed command unit outputs a command speed value to a motor of the corresponding press machine on the basis of the press angle reference value and the press angle detection value, wherein the driving unit controls a speed of the motor of the corresponding press machine on the basis of the command speed value, and wherein the press angle control device further comprises a correction unit which corrects the command speed value or the press angle reference value so that a difference between the press angle reference value and the press angle for each of the press machines is within a predetermined range.

According to the press machine facility, the reference value output unit outputs the press angle reference value, the press angle detection unit detects the press angle of the corresponding press machine and outputs the press angle detection value, the speed command unit outputs the command speed value to the motor of the corresponding press machine on the basis of the press angle reference value and the press angle detection value, the driving unit controls a speed of the motor of the corresponding press machine on the basis of the command speed value, and the correction unit corrects the command speed value or the press angle reference value so that a difference between the press angle reference value and the actual press angle for each of the press machines is within a predetermined range, thereby reducing a difference (i.e., a press angle control error) caused by a press load variation.

Additionally, since the press angle reference value is independent from the press angle detection value of each press machine, the press angle reference value does not vary due to the press load variation. Also, since the press angle control is carried out on the basis of the press angle reference value, the press load variation of one press machine does not act on the other press machine.

In order to achieve the above-described object, according to the invention, there is provided a press angle control method for a press machine facility provided with a plurality of press machines constituting a press line, wherein a reference value output unit outputs a press angle reference value, wherein in each of the press machines, a press angle detection unit detects a press angle of the press machine and outputs a press angle detection value, a speed command unit outputs a command speed value to a motor of the press machine on the basis of the press angle reference value and the press angle detection value, and a driving unit controls a speed of the motor of the press machine on the basis of the command speed value, and wherein a correction unit corrects the command speed value or the press angle reference value so that a difference between the press angle reference value and the press angle for each of the press machines is within a predetermined range.

According to the press angle control method for the press machine facility, the reference value output unit outputs the press angle reference value, in each of the press machines, the press angle detection unit detects the press angle of the corresponding press machine and outputs the press angle detection value, the speed command unit outputs the command speed value to the motor of the corresponding press machine on the basis of the press angle reference value and the press angle detection value, the driving unit controls a speed of the motor of the corresponding press machine on the basis of the command speed value, and the correction unit corrects the command speed value or the press angle reference value so that a difference between the press angle reference value and the actual press angle for each of the press machines is within a predetermined range, thereby reducing the difference (i.e., the press angle control error) caused by the press load variation or the press speed variation.

Additionally, since the press angle reference value is independent from the press angle detection value for each press machine, the press angle reference value does not vary due to the press load variation. Also, since the press angle control is carried out on the basis of the press angle reference value, the press load variation of one press machine does not act on the other press machine.

According to the preferred embodiments of the invention, in the above-described method, the correction unit corrects the command speed value or the press angle reference value so that a press angle difference between the adjacent press machines is within a predetermined range.

As described above, since the correction unit corrects the command speed value or the press angle reference value so that the press angle difference between the adjacent press machines is within a predetermined range, it is possible to reduce the press angle difference between the adjacent press machines and to perform a synchronization control or a phase difference control of the adjacent press machines.

According to the invention, it is possible to reduce the press angle control error caused by the press load variation and to prevent the press load variation of one press machine from acting on the other press machine.

### BRIEF DESCRIPTION OF THE DRAWINGS

FIG. 1 is a configuration diagram showing a press machine facility according to a first embodiment of the invention.

FIG. 2 is a configuration diagram showing each press machine.

FIG. 3 is a graph showing a relationship between a correction amount and a press angle detection value or a press angle reference value.

FIGS. 4A through 4G are graphs showing schematic operations of the press machine without a correction unit.

FIGS. 5A through 5G are graphs showing schematic operations of the press machine provided with the correction unit according to the first embodiment.

FIG. 6 is a configuration diagram showing the press machine facility according to the second embodiment of the invention.

FIG. 7 is a graph showing another relationship between the correction amount and the press angle detection value or the press angle reference value.

### DESCRIPTION OF THE PREFERRED EMBODIMENTS

Hereinafter, preferred embodiments of the invention will be described in detail with reference to the accompanying drawings. In addition, in the respective drawings, the same reference numerals are given to the same components and the repetitive description thereof will be omitted.

### First Embodiment

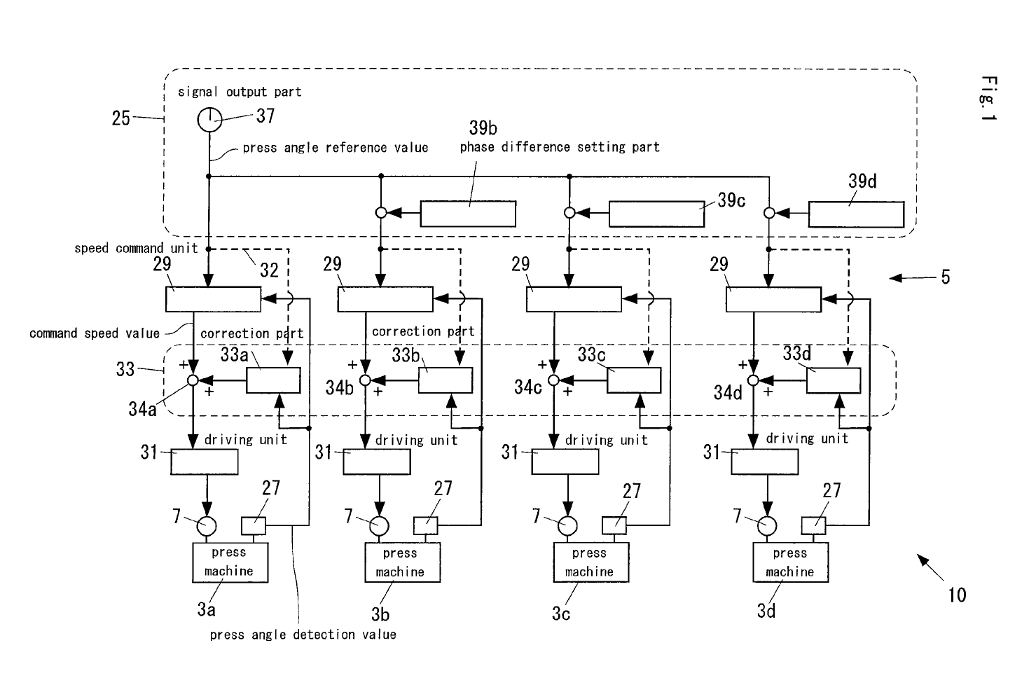

FIG. 1 is a configuration diagram showing a press machine facility 10 according to an embodiment of the invention. The press machine facility 10 includes a plurality of press machines 3a to 3d and a press angle control device 5.

The plurality of press machines 3a to 3d (four units in this example) constitutes a press line. In the press line, a workpiece such as a panel is sequentially conveyed from the upstream press machine to the downstream press machine so that a pressing process is sequentially carried out by the press machines 3a to 3d. In this way, the pressing process is continuously carried out to efficiently produce the panel.

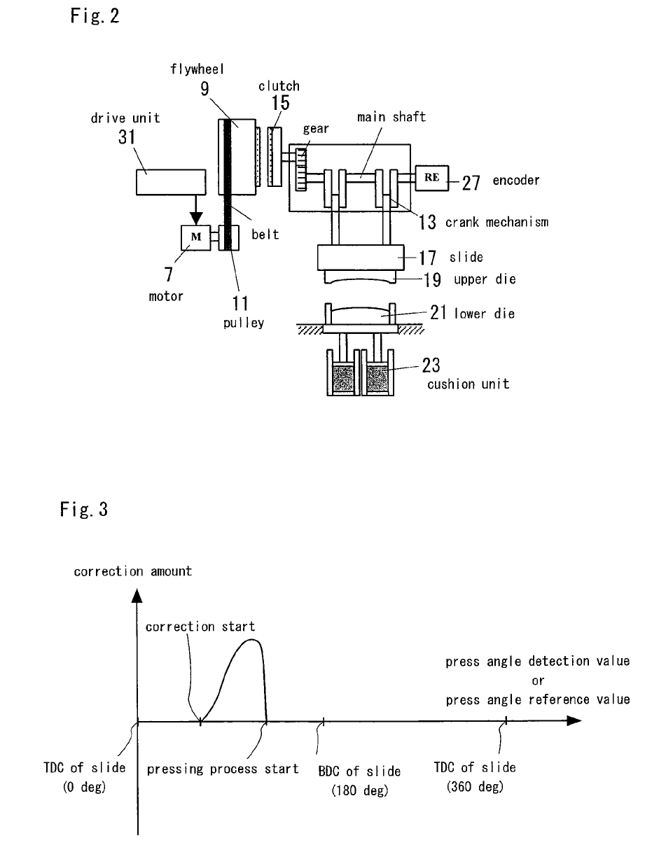

Each of the press machines 3a to 3d has, for example, the configuration shown in FIG. 2.

As shown in FIG. 2, each of the press machines 3a to 3d includes a motor 7 for the pressing process, a flywheel 9 configured to be rotationally driven by the motor 7 so as to accumulate rotation energy, a pulley 11 configured to transmit a rotary driving force of the motor 7 to the flywheel 9, a crank mechanism 13 configured to receive the rotary driving force from the flywheel 9, a clutch 15 configured to connect or disconnect the flywheel 9 and the crank mechanism 13 to or from each other, a slide 17 configured to be connected to the crank mechanism 13, an upper die 19 configured to be attached to a lower surface of the slide 17, a lower die 21 configured to be provided below the upper die 19, and a cushion unit 23 configured to receive a press load.

With such a configuration, during the pressing process, the clutch 15 connects the flywheel 9 to the crank mechanism 13, and the crank mechanism 13 performs eccentric motion in terms of the rotary driving force generated from the motor 7, thereby performing the pressing process in such a manner that the slide 17 moves down by interposing the workpiece between the upper die 19 and the lower die 21. In addition, during the pressing process, the slide 17 moves up upon arriving at BDC (Bottom Dead Center), and moves down again upon arriving at TDC (Top Dead Center).

As shown in FIG. 1, the press angle control device 5 includes a reference value output unit 25, a correction unit 33, a press angle detection unit 27, a speed command unit 29, and a driving unit 31 provided for each press machine.

The reference value output unit 25 outputs a press angle reference value occasionally during the operation of the press machine facility 10. The press angle reference value is a reference value, independent from actual press angles of the press machines 3a to 3d. In addition, the press angle may be a rotary angle of a main shaft of the crank mechanism 13 (may vary in a range of 0 to 360 degree), and indicates an elevation position of the slide 17. That is, in order to perform the pressing process, the slide 17 continuously performs one-cycle motion in which the slide 17 moves down from a predetermined position (for example, TDC) to BDC and moves up again to return to the predetermined position. At this time, the press angle corresponds to the rotary angle (0 to 360 degree) of the main shaft of the crank mechanism 13, that is, the elevation position of the slide 17 during the one-cycle motion. In this example, the reference value output unit 25 outputs the press angle reference value so that the press angle increases at a predetermined rate in time, and continuously and periodically outputs the press angle in a range of 0 to 360 degree so that the press angle of 0 degree is output when the press angle reference value arrives at 360 degree.

In the example shown in FIG. 1, the reference value output unit 25 includes a signal output part 37, phase difference setting parts 39b, 39c, and 39d.

The signal output part 37 outputs the press angle reference value, and the phase difference setting parts 39b, 39c, and 39d correct the press angle reference value output from the signal output part 37 so as to have a predetermined phase difference. Subsequently, the corrected press angle reference value is output.

Between the press angle reference valve output from the signal output part 37 and the press angle reference valve corrected by the phase difference setting part 39b, a phase difference is maintained at constant valve.

During the operation of the press machine facility 10, each press angle detection unit 27 detects the press angle of the corresponding press machine occasionally, and outputs the detection value as a press angle detection value. In this example, each press angle detection unit 27 is an encoder which detects a rotary angle of the main shaft of the crank mechanism 13 and outputs the detection value as the press angle detection value. In addition, a resolver may be used instead of the encoder. Each press angle detection unit 27 may be configured as a unit other than the encoder or the resolver so long as the press angle is detected.

During the operation of the press machine facility 10, each speed command unit 29 outputs a command speed value to the motor 7 of the corresponding press machine occasionally on the basis of the press angle reference value and the press angle detection value. In this example, when there is no difference between the input press angle reference value and the input press angle detection value, each speed command unit 29 outputs a reference speed value obtained by differentiating the input press angle reference value in time as a command speed value. However, each speed command unit 29 outputs the same prior value at a time point when the press angle reference value varies from 360 degree to 0 degree. In this example, each speed command unit 29 outputs the predetermined command speed value.

In addition, when the input press angle reference value is larger than the input press angle detection value, each speed command unit 29 increases the reference speed value in accordance with a difference between the press angle reference value and the press angle detection value (for example, by an amount proportional to the difference), and outputs the corresponding increased command speed value.

Meanwhile, when the input press angle reference value is smaller than the input press angle detection value, each speed command unit 29 decreases the reference speed value in accordance with a difference between the press angle reference value and the press angle detection value (for example, by an amount proportional to the difference), and outputs the corresponding decreased command speed value.

During the operation of the press machine facility 10, each driving unit 31 controls a speed of the motor of the corresponding press machine occasionally on the basis of the command speed value. For example, each driving unit 31 controls the motor 7 so that a rotary speed of the motor 7 is equal to the input command speed value on the basis of a detection value detected by a detector (not shown) for detecting the rotary speed of the motor 7.

In the example shown in FIG. 1, the correction unit 33 includes correction parts 33a to 33d and adders 34a to 34d provided for each press machine. During the operation of the press machine facility 10, the correction unit 33 (i.e., the correction parts 33a to 33d and the adders 34a to 34d) controls the command speed value occasionally so that a difference between the press angle reference value and the actual press angle for each press machine is within a predetermined range. In this embodiment, the correction unit 33 (i.e., the correction parts 33a to 33d and the adders 34a to 34d) corrects the command speed value so that the command speed value increases until a time point when a pressing process starts while the slide 17 moves down.

In the example shown in FIG. 1, each of the correction parts 33a to 33d corrects the command speed value so that a difference between the press angle reference value and the press angle of the corresponding press machine is within a predetermined range on the basis of the press angle detection value, output from the press angle detection unit 27. Instead of the correction based on the press angle detection value, as depicted by a dashed arrow 32 in FIG. 1, each of the correction parts 33a to 33d may perform the correction on the basis of the press angle reference value, output from the reference value output unit 25.

Such a correction based on the press angle detection value or the press angle reference value may be carried out in a manner shown in a graph of FIG. 3. In the graph shown FIG. 3, a horizontal axis indicates the press angle detection value (the press angle reference value in a case of the correction based on the press angle reference value) input to each of the correction parts 33a to 33d, and a vertical axis indicates the correction amount added to the command speed value. In FIG. 3, the correction amount is 0 or a positive value before the pressing process starts after the slide is located at TDC, and again is equal to 0 after the pressing process starts. Specifically, in the example shown in FIG. 3, the correction amount gradually increases as a positive value until a time point just before the pressing process starts after a correction start time point when the press angle reference value or the press angle detection value input to each of the correction parts 33a to 33d is equal to a predetermined correction start value, and the correction amount decreases from a time point just before the pressing process starts and is equal to 0 at a time point when the pressing process starts.

Next, an operation of the press angle control device 5 will be described.

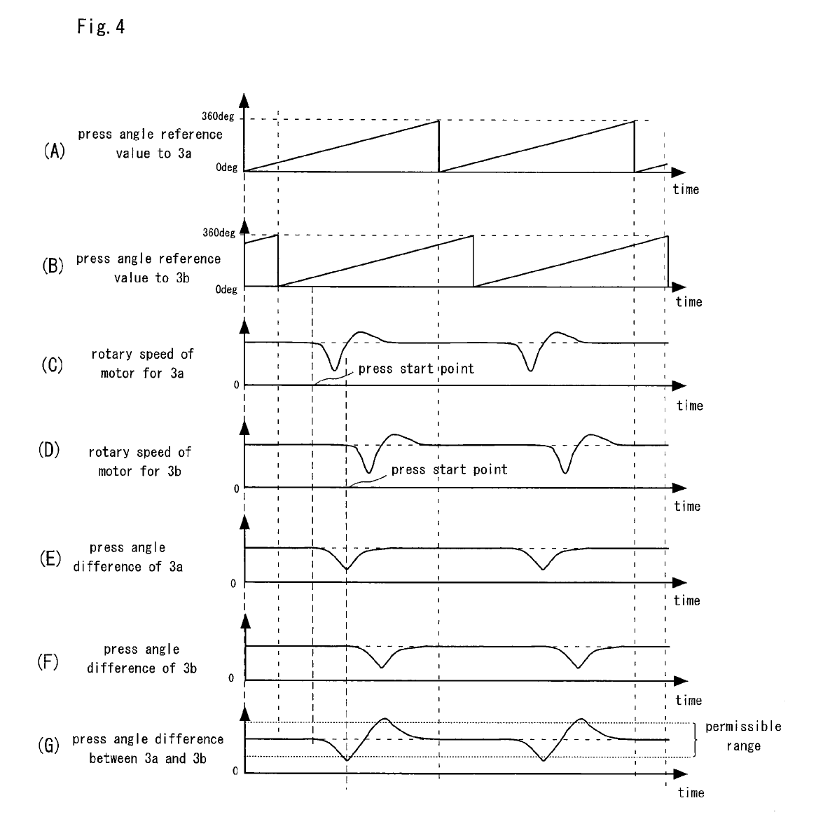

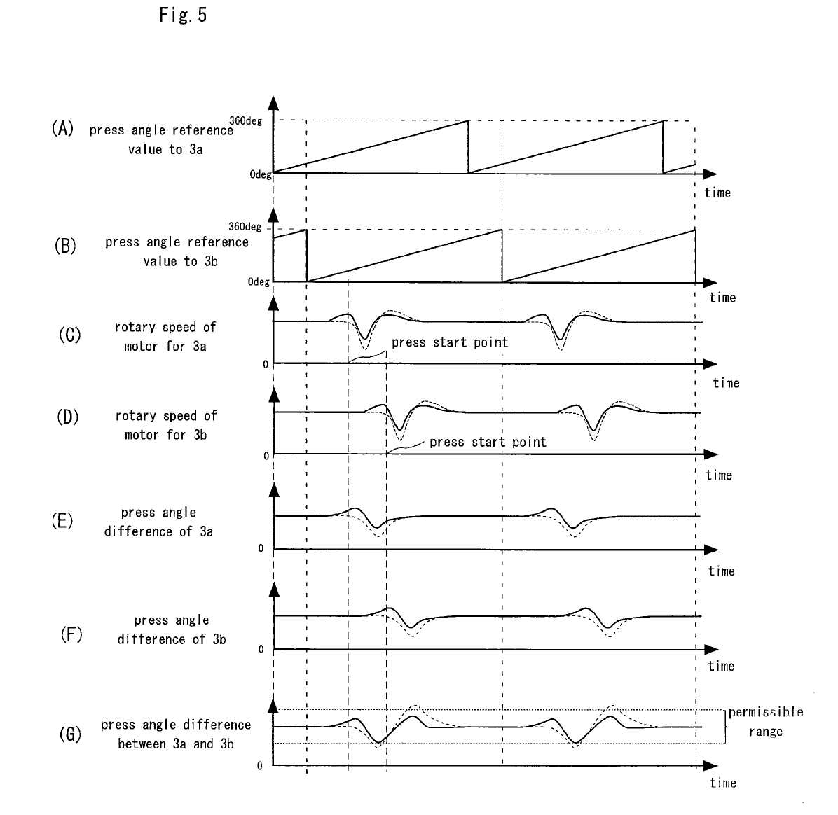

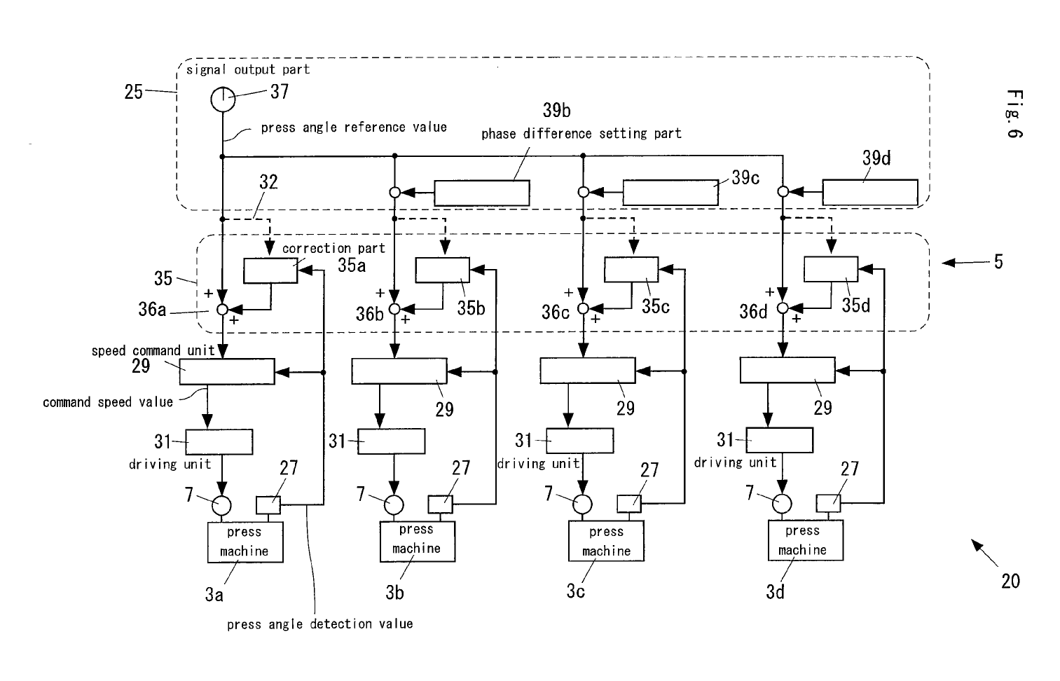

FIG. 4 shows a schematic operation of the press machine facility without the correction unit 33 shown in the configuration in FIG. 1. FIG. 5 shows a schematic operation of the press machine facility in FIG. 1.

In FIGS. 4 and 5, a horizontal axis indicates a time. Additionally, in FIGS. 4 and 5, a vertical axis in a graph (A) indicates the press angle reference value output from the reference value output unit 25 to the press machine 3a, a vertical axis in a graph (B) indicates the press angle reference value output from the reference value output unit 25 to the press machine 3b, a vertical axis in a graph (C) indicates a rotary speed of the motor 7 of the press machine 3a, a vertical axis in a graph (D) indicates a rotary speed of the motor 7 of the press machine 3b, a vertical axis in a graph (E) indicates a difference between the press angle reference value and the actual press angle of the press machine 3a, a vertical axis in a graph (F) indicates a difference between the press angle reference value and the actual press angle of the press machine 3b, and a vertical axis in a graph (G) indicates a difference between the actual press angle of the press machine 3a and the actual press angle of the press machine 3b.

In addition, in FIGS. 4 and 5, although the operations of the press machines 3a and 3b are illustrated, the operations of the press machine 3c and 3d are the same as those of the press machines 3a and 3b except that the operations of the press machines 3c and 3d have a predetermined phase different from that of the press machines 3a and 3b.

First, a case shown in FIG. 4 will be described. A cycle is repeated in which the press angle reference value output from the reference value output unit 25 increases at a predetermined rate in time from 0 to 360 degree. As shown in FIG. 4, in each of the press machines 3a to 3d, energy consumption is large during a pressing process time in which a press force of the upper die 19 acts on the workpiece, but energy consumption is comparatively small during a non-pressing process time in which the press force of the upper die 19 does not act on the workpiece. Accordingly, a press load variation (a torque variation of the motor 7) for one cycle becomes large.

In addition, although the large flywheel 9 is provided in the example shown in FIG. 2 in order to restrict a press load variation, a comparatively large press load variation occurs. Additionally, in the press machines 3a to 3d having such a flywheel 9, an inertia involved with rotating motion of the motor 7 increases in accordance with the large flywheel 9, thereby deteriorating a control of the motor speed.

In the graphs (C) and (D) shown in FIG. 4, a press speed (i.e., a rotary speed of the motor 7) decreases in some areas, which means that kinetic energy of the flywheel 9 reduces during the pressing process in which the press machines 3a to 3d press the workpiece. Since a difference between the press angle reference value and the press angle detection value increases due to the decrease of the press speed, as described above, the speed command unit 29 increases the command speed value on the basis of the difference, and outputs the increased command speed value. Accordingly, an advance delay of in the press angle is restored. In this case, since the rotary speed of the motor 7 largely decreases whenever energy transmitted from the flywheel 9 reduces, a control error of the press angle increases, and thus it is difficult to maintain a press angle difference among the press machines 3a to 3d to be within a predetermined range (a permissible range).

On the contrary, in this embodiment, an operation shown in FIG. 5 is carried out.

In FIG. 5, in graphs (C) to (G), the solid line indicates this embodiment provided with the correction unit, and the dashed line indicates a case without the correction unit for a comparison (i.e., a case shown in FIG. 4).

As shown in FIG. 5, the correction unit 33 performs a correction for increasing the command speed value input to the driving unit 31 in accordance with the correction amount shown in FIG. 3 before the reduction of the kinetic energy of a driving system (which includes the flywheel 9, the crank mechanism 13, and the slide 17) of the press machine 3a, 3b, 3c or 3d, that is, before the pressing process time in which the press force of the upper die acts on the workpiece. Accordingly, since the kinetic energy of the driving system temporarily increases, it is possible to restrict the decrease of the rotary speed of the motor 7 during the pressing process and to reduce the press angle difference among the press machines 3a to 3d, thereby maintaining the press angle difference within a predetermined range (a permissible range).

With the press machine facility 10 according to the invention, it is possible to obtain the following advantages (1) to (4).

(1) The reference value output unit 25 outputs the press angle reference value. Each press angle detection unit 27 detects the press angle of the corresponding press machine and outputs the press angle detection value. Each speed command unit 29 outputs the command speed value to the motor 7 of the corresponding press machine on the basis of the press angle reference value and the press angle detection value. Each driving unit 31 controls the motor speed of the corresponding press machine on the basis of the command speed value. The correction unit 33 corrects the command speed value so that a difference between the press angle reference value and the press angle for each of the press machines 3a to 3d is within a predetermined range. Accordingly, it is possible to restrict a difference caused by the press load variation (i.e., the press angle control error).

(2) Also, since the press angle reference value is independent from the press angle detection value for each of the press machines 3a to 3d, the press angle reference value does not vary due to the press load variation. Since the press angle control is carried out on the basis of such press angle reference value, the press load of one press machine cannot act on the other press machine.

(3) Also, since the correction unit 33 corrects the command speed value so that the command speed value increases until a time point when the pressing process starts, it is possible obtain the following advantages. In general, since the press speed decreases due to the press load during the pressing process to thereby delay the advance of the press angle, a difference between the press angle reference value and the actual press angle tends to be maximum during the pressing process. According to the operation of the correction unit 33, since the correction for increasing the command speed value is carried out before the advance of the press angle is delayed due to the decrease of the press speed in accordance with the press load, that is, before the pressing process starts, it is possible to efficiently reduce a difference between the press angle reference value and the press angle during the pressing process, thereby reducing the maximum difference value.

(4) Also, as described above, since each speed command unit 29 sets the reference speed value obtained by differentiating the input press angle reference value in time to the command speed value when there is no difference between the press angle reference value and the press angle detection value, even when the press production speed (i.e., an increase rate in time of the press angle reference value) varies during the pressing process, it is possible to automatically handle such a case, and thus to maintain the press angle difference between the press angle reference value and the press angle for each of the press machines 3a to 3d within a predetermined range.

### Second Embodiment

FIG. 6 is a configuration diagram showing a press machine 20 according to the second embodiment of the invention. A configuration of the second embodiment is the same as that of the first embodiment except for the correction unit.

In the second embodiment, as shown in FIG. 6, a correction unit 35 includes correction parts 35a to 35d and adders 36a to 36d provided for each press machine. During the operation of the press machine facility 20, the correction unit 35 (i.e., the correction parts 35a to 35d and the adders 36a toe 36d) controls the press angle reference value output from the reference value output unit 25 (i.e., the signal output part 37 or the phase difference setting parts 39b, 39c, and 39d) occasionally so that a difference between the press angle reference value and the press angle of the press machines 3a to 3d is within a predetermined range. In this embodiment, the correction unit 35 (i.e., the correction parts 35a to 35d and the adders 36a to 36d) corrects the press angle reference value so that the command speed value increases until a time point when the pressing process starts while the slide 17 moves down. That is, the press angle reference value increases.

In the example shown in FIG. 6, each of the correction parts 35a to 35d corrects the press angle reference value so that a difference between the press angle reference value and the press angle of the corresponding press machine is within a predetermined range on the basis of the press angle detection value, corresponding to a reference such as a correction start time point, output from the press angle detection unit 27. Instead of the correction based on the press angle detection value, as depicted by the dashed arrow 32 in FIG. 6, each of the correction parts 35a to 35d may perform the correction on the basis of the press angle reference value, corresponding to a reference such as a correction start time point, output from the reference value output unit 25. The correction amount of the reference press angle corrected by the correction parts 35a to 35d may be the same as that of the first embodiment or may be the correction amount shown in the graph of FIG. 3.

In the press machine facility 20 according to the second embodiment, it is possible to obtain the same advantage as that of the first embodiment.

### Other Embodiments

The present invention is not limited to the above-described embodiments, but may be, of course, modified into various forms without departing from the scope of the invention.

For example, in the first and second embodiments, although it has been described about a case in which the press machine facility is operated by the phase difference control for maintaining the press angle difference among the plurality of press machines 3a to 3d within a predetermined range, the invention is not limited thereto. That is, in the first and second embodiments, the press machine facility may be operated by a synchronous control for maintaining the press angle difference among the plurality of press machines 3a to 3d to be 0. In this case, the phase difference setting parts 39b, 39c, and 39d shown in FIGS. 1 and 6 are omitted, and thus the same press angle reference value is input to the press machines 3a to 3d. Also, in this case, other configurations and operations are the same as those of the first and second embodiments.

In the first or second embodiment, the correction unit 33 (i.e., the correction parts 33a to 33d and the adders 34a to 34d) or the correction unit 35 (i.e., the correction parts 35a to 35d and the adders 36a to 36d) may correct the command speed value or the press angle reference value so that the command speed value decreases after a time point when the pressing process starts. Accordingly, in a case where the press angle is excessively advanced by the correction for increasing the command speed value, it is possible to correct the excessive advance of the press angle.

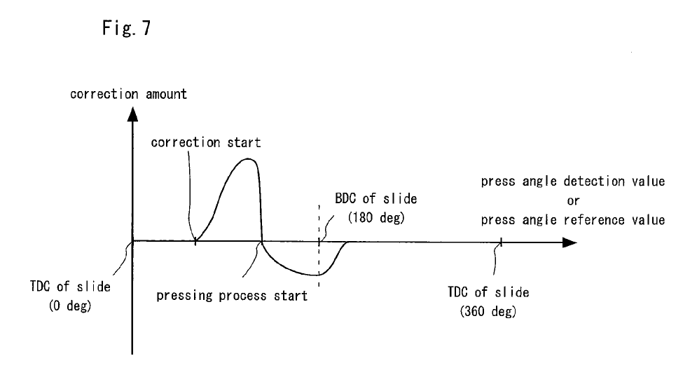

In this case, the correction amount of the correction unit 33 (i.e., the correction parts 33a to 33d) or the correction unit 35 (i.e., the correction parts 35a to 35d) may be that shown in FIG. 7 instead of FIG. 3. In the graph shown in FIG. 7, a horizontal axis indicates the press angle detection value input to the correction parts 33a to 33d or the correction parts 35a to 35d (the press angle reference value in a case of the correction based on the press angle reference value), and a vertical axis indicates the correction amount of the correction unit 33 or 35 added to the press angle reference value or the command speed value. In FIG. 7, the correction amount is 0 or a positive value until a time point before the pressing process starts after the slide is located at TDC, and is a negative value or 0 after the pressing process starts.

Specifically, in the example shown in FIG. 7, the correction amount gradually increases from a positive value until a time point just before the pressing process starts after a correction start time point when the press angle reference value or the press angle detection value input to each of the correction parts 33a to 33d or the correction parts 35a to 35d is equal to a predetermined correction start value, and the correction amount decreases from a time point just before the pressing process starts and is equal to 0 at a time point when the pressing process starts. Subsequently, the correction amount gradually increases from a negative value until a time point when the press angle reference value or the press angle detection value input to each of the correction parts 33a to 33d or each of the correction parts 35a to 35d is equal to 180 degree (BDC of the slide). Subsequently, the correction amount gradually decreases until a correction end time point when the press angle reference value or the press angle detection value input to each of the correction parts 33a to 33d or the correction parts 35a to 35d is equal to a predetermined correction end value.

In this case, other configurations may be the same as those of the first and second embodiments.

Also, in the first and second embodiments, the flywheel 9 is used, but the flywheel 9 may be omitted. That is, the invention may be applied to the press machine facility provided with a plurality of press machines 3a to 3d without the flywheel 9.

Also, the speed command unit 29 may be configured as a unit for performing a PI control of a speed of the motor 7 on the basis of the input press angle reference value and the press angle detection value.

1. A press angle control device for a press machine facility provided with a plurality of press machines constituting a press line, the press angle control device comprising:
a reference value output unit which outputs a press angle reference value; and
a press angle detection unit, a speed command unit, and a driving unit which are provided for each of the press machines,
wherein the press angle detection unit detects a press angle of the corresponding press machine and outputs a press angle detection value,
wherein the speed command unit outputs a command speed value to a motor of the corresponding press machine on the basis of the press angle reference value and the press angle detection value,
wherein the driving unit controls a speed of the motor of the corresponding press machine on the basis of the command speed value, and
wherein the press angle control device further comprises a correction unit which corrects the command speed value or the press angle reference value so that a difference between the press angle reference value and the press angle for each of the press machines is within a predetermined range.

2. The press angle control device according to claim 1, wherein the correction unit corrects the command speed value or the press angle reference value so that a press angle difference between the adjacent press machines is within a predetermined range.

3. The press angle control device according to claim 1, wherein the correction unit corrects the command speed value or the press angle reference value so that the command speed value increases until a time point when a pressing process starts.

4. The press angle control device according to claim 3, wherein the correction unit corrects the command speed value or the press angle reference value so that the command speed value decreases after the pressing process starts.

5. A press machine facility comprising:
a plurality of press machines which constitutes a press line; and
a press angle control device which controls press angles of the plurality of press machines,
wherein the press angle control device includes a reference value output unit which outputs a press angle reference value; and a press angle detection unit, a speed command unit, and a driving unit which are provided for each of the press machines,
wherein the press angle detection unit detects a press angle of the corresponding press machine and outputs a press angle detection value,
wherein the speed command unit outputs a command speed value to a motor of the corresponding press machine on the basis of the press angle reference value and the press angle detection value,
wherein the driving unit controls a speed of the motor of the corresponding press machine on the basis of the command speed value, and
wherein the press angle control device further comprises a correction unit which corrects the command speed value or the press angle reference value so that a difference between the press angle reference value and the press angle for each of the press machines is within a predetermined range.

6. A press angle control method for a press machine facility provided with a plurality of press machines constituting a press line,
wherein a reference value output unit outputs a press angle reference value,
wherein in each of the press machines, a press angle detection unit detects a press angle of the press machine and outputs a press angle detection value, a speed command unit outputs a command speed value to a motor of the press machine on the basis of the press angle reference value and the press angle detection value, and a driving unit controls a speed of the motor of the press machine on the basis of the command speed value, and
wherein a correction unit corrects the command speed value or the press angle reference value so that a difference between the press angle reference value and the press angle for each of the press machines is within a predetermined range.

7. The press angle control method according to claim 6, wherein the correction unit corrects the command speed value or the press angle reference value so that a press angle difference between the adjacent press machines is within a predetermined range.
